(19) United States
(12) Patent Application Publication
(10) Pub. No.: US 2021/0334775 A1
(43) Pub. Date: Oct. 28, 2021

(54) IMPROVED METHOD AND SYSTEM FOR DETERMINING LOCATIONS OF POINT-OF-SALE TERMINALS

(71) Applicant: QUANTIUM DIGITAL PTY LIMITED, Sydney, New South Wales (AU)

(72) Inventor: Frederick Wagner KRUGER, Sydney, New South Wales (AU)

(73) Assignee: QUANTIUM DIGITAL PTY LIMITED, Sydney, New South Wales (AU)

(21) Appl. No.: 16/333,553

(22) PCT Filed: Nov. 30, 2018
(86) PCT No.: PCT/AU2018/051287

§ 371 Date: Mar. 14, 2019

(51) Int. Cl. G06Q 20/20

(52) U.S. Cl. CPC G06Q 20/202

(57) ABSTRACT

The present invention generally relates to methods and systems for determining the location of a subject point of sale (POS) terminal (102). Transaction data (111) relating to at least one transaction on the subject POS terminal is received; the transaction data (111) including a transaction time (112) and a payment object (114). Further transaction data (111) relating to at least one transaction with the payment object is received from at least one non-subject POS (103-108), the data including a transaction time (112), terminal text (113) and payment object (114). The location of the subject POS (102) is then determined by extracting location information from the terminal text from the non-subject POS terminal and the difference in the transaction times of the transaction on the subject POS (102) and the transaction on the non-subject POS (103-108).

### TECHNICAL FIELD

This disclosure relates to methods and systems for determining locations of point-of-sale terminals. In particular, embodiments relate to determining locations of point-of-sale terminals based on a point-of-sale terminal text.

### BACKGROUND

There are a large number of point-of-sale (POS) terminals deployed at many different locations, which makes cash-less payments convenient and ubiquitous. As consumers adopt the cash-less option for more and more payments, it becomes increasingly difficult to determine at a later stage where a payment card has been used. The main difficulty is that often the only information that is available is the date and amount of a transaction as well as a textual description. While it could be possible that the textual description accurately represents where the card was used, in practice it is often difficult because the textual description is typically the terminal text, as provided by the POS terminal. Further, the terminal text is entered by the merchant or the merchant's bank and is often inaccurate as to the location of the POS terminal. For example, the terminal text may be the name of the parent company with an indication of the location of the headquarters but not the location of the actual POS terminal.

There are technical solutions available to address this problem, such as by linking a GPS position to a transaction. However, this requires additional hardware or access to mobile phones in the case of mobile payment apps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

According to a first aspect of the invention there is provided a method for determining a location of a subject point-of-sale (POS) terminal, the method comprising:

receiving transaction data from the subject POS terminal including an indication of a transaction time and a payment object used for each of at least one transaction on the subject POS terminal;

receiving transaction data from at least one non-subject POS terminal for at least one transaction with the payment object, the transaction data including an indication of a transaction time, terminal text and payment object used for each of the at least one transaction on the non-subject POS terminal;

determining the location of the subject POS terminal by extracting location information from the terminal texts from the at least one non-subject POS terminal based on a difference in the transaction time between the at least one transaction of the subject POS terminal and the at least one transaction of the non-subject POS terminal.

In some examples it may be an advantage that location information is extracted from terminal texts of the non-subject terminals based on the transaction time difference of the same payment object because this allows the determination of the location of the subject POS terminal even in cases where the locations of all other non-subject POS terminals are also unknown. It may be a further advantage that POS locations so determined can be used as input data for machine learning algorithms, and/or to improve security of POS terminal transactions, such for preventing fraud on the payment object since an improved location is known about transactions. It may be a further advantage that the location can be determined from the available transaction data without any additional hardware and without any changes at the point of sale.

Optionally, the method also comprises:

receiving transaction data for at least one transaction with the payment object from multiple non-subject POS terminals; and

determining the location of the at least one non-subject POS terminal by extracting location information from the terminal texts from multiple non-subject POS terminals based on a difference in the transaction time between the at least one transaction of the subject POS terminal and the at least one transaction of the multiple non-subject POS terminals.

In some examples, it is an advantage of this embodiment that the locations of non-subject POS terminals can be determined.

The transaction data from the subject POS terminal optionally includes an indication of transaction time and one of multiple payment objects used for each of multiple transactions on the subject POS terminal, and wherein the transaction data from the at least one non-subject POS terminal includes an indication of transaction time, terminal text and one of multiple payment objects used for each of the multiple transactions on the at least one non-subject POS terminal.

Optionally, the method for determining the location of the subject POS further comprises updating the location using the transaction data from transactions with the payment object from the multiple non-subject POS terminals.

In some examples, it is an advantage of this embodiment that the location of the subject POS can be updated using transaction data generated by transactions at different non-subject POSs, thereby refining the determined location with the additional transaction data.

Determining the location of the subject POS terminal optionally further comprises updating the location using the transaction data from the at least one non-subject POS terminal using different payment objects.

In some examples, it is an advantage of this embodiment that the location of the subject POS can be updated using transaction data generated by different payment objects thereby refining the determined location with the additional transaction data.

Optionally, the method further comprising:

creating multiple pairs of transactions, each pair comprising one transaction of the subject POS terminal by a payment object and one transaction of one of the multiple non-subject POS terminals by the same payment object.

Creating the multiple pairs of transactions optionally comprises creating only those pairs of transactions where the transactions are not more than a threshold number of transactions apart from each other in a sequence of transactions by that payment object.

In some examples, it is an advantage that limiting the number of pairs by a threshold number reduces the overall number of pairs to a manageable level, which could otherwise grow quickly to a level that is difficult to process on existing computer hardware.

Optionally, the method further comprises excluding transactions where a payment object was not present.

The method optionally further comprising calculating a time difference between the transactions of each of the multiple pairs of transactions and determining the location of the subject POS terminal based on the time difference.

Optionally, the method further comprises one or more of:

removing pairs with transactions over a first threshold number of transactions of the same non-subject POS terminal;

removing pairs with transactions over a second threshold number of transactions of the same brand as identified from the terminal text;

removing pairs with transactions over a third threshold number of transactions per terminal after a fourth threshold number of transactions;

removing pairs of transactions over a fifth threshold number of pairs.

The method optionally further comprising converting the terminal text of each non-subject POS terminal into multiple terminal text tokens.

Optionally, the method further comprising matching the multiple terminal text tokens to predefined location tokens to identify one or more matching location tokens for each terminal text of the non-subject POS terminals.

The method optionally further comprising associating each of the one or more matching location tokens with a geographical location.

Optionally, the method further comprising calculating a plausibility score based on a distance between the geographical location of each of the one or more matching location tokens and a candidate location for the subject POS terminal.

The plausibility score is optionally based on the time difference and distance or travel speed or both.

In some examples, it is an advantage that the plausibility score is based on the time difference because this way the method can extract location information based on a difference in transaction times. Further, as the plausibility score is calculated for the tokens instead of the terminal text itself, it is possible to infer locations even when no terminal text matches one particular location exactly.

Optionally, the plausibility score is binary to indicate whether a trip between locations within the time difference is plausible.

The method optionally further comprising determining a plausibility weight by combining the plausibility scores of multiple transactions of non-subject terminals for one candidate location of the subject terminal.

Optionally, combining the plausibility score comprises calculating a weighted average that is weighted by a weight value for each transaction.

The method optionally further comprising calculating an average plausible time difference based on the plausibility weight for each of multiple candidate locations.

Optionally, determining the location of the subject POS terminal comprises selecting the candidate location with the highest plausibility weight and/or lowest average plausible time difference.

According to another aspect of the invention, there is provided software that, when executed by a computer, causes the computer to perform the method variously described above.

According to a further aspect of the invention, there is provided a computer system for determining a location of a subject point-of-sale (POS) terminal, the computer system comprising:

in input port to receive
transaction data from the subject POS terminal including an indication of a transaction time and a payment object used for each of at least one transaction on the subject POS terminal, and
transaction data from at least one non-subject POS terminal for at least one transaction with the payment object, the transaction data including an indication of a transaction time, terminal text and payment object used for each of at least one transaction on the non-subject POS terminal; and

a processor to determine the location of the subject POS terminal by extracting location information from the terminal texts from the at least one non-subject POS terminal based on a difference in the transaction time between the at least one transaction of the subject POS terminal and the at least one transaction of the non-subject POS terminal.

Optional features of the software and system includes the optional features described above in relation to the method.

### BRIEF DESCRIPTION OF DRAWINGS

Examples of the present disclosure will be described with reference to the figures below:

FIG. 1 is an example illustration of a computer network with a server for determining an estimated location of point-of-sale terminal based on transaction data that includes a textual terminal descriptor.

FIG. 2 illustrates a method for determining a location of subject point-of-sale terminal.

FIG. 3a and FIG. 3b illustrate example transaction data.

FIG. 4 illustrates example transaction pairs.

FIG. 5 illustrates example filtered transaction pairs.

FIG. 6 illustrates example time difference calculation per transaction pair.

FIG. 7 illustrates example filtered transaction pairs based on the data in FIG. 5.

FIG. 8 illustrates an example filtered and ordered set of transaction pairs.

FIG. 9 illustrates a example weighting applied to each transaction combination.

FIG. 10 illustrates example tokenisation applied to the terminal text.

FIG. 11 illustrates example matching based on the tokens in the terminal text.

FIG. 12 illustrates example calculation of word position for each match in FIG. 10.

FIG. 13 illustrates example location tokens for the corresponding terminal text.

FIG. 14 illustrates example location name and type for the corresponding terminal text.

FIG. 15 illustrates example latitude and longitude as well as a word position for each corresponding terminal text.

FIG. 16 illustrates example weighting of locations for each terminal.

FIG. 17 illustrates example determination of candidate locations for each terminal.

FIG. 18 illustrates an example plausibility score for each candidate location.

FIG. 19a and FIG. 19b illustrates an example reduced plausibility score per candidate location.

FIG. 20 illustrates example weighting and plausibility of candidate locations.

FIG. 21 illustrates example calculations of plausibility weight and average plausible time difference.

FIG. 22a illustrates example reduced candidate locations.

FIG. 22b illustrates an example estimated location of the subject point-of-sale terminal.

FIG. 23 illustrates an example method for determining an estimated location of point-of-sale terminal based on transaction data that includes a textual terminal descriptor

FIG. 24 illustrates an example system for determining an estimated location of point-of-sale terminal based on transaction data that includes a textual terminal descriptor.

### DESCRIPTION OF EMBODIMENTS

Embodiments generally relate to methods and systems for determining locations of point-of-sale terminals. In particular, embodiments relate to determining an estimated location of point-of-sale terminal based on transaction data that includes a textual terminal descriptor also referred to as a terminal text.

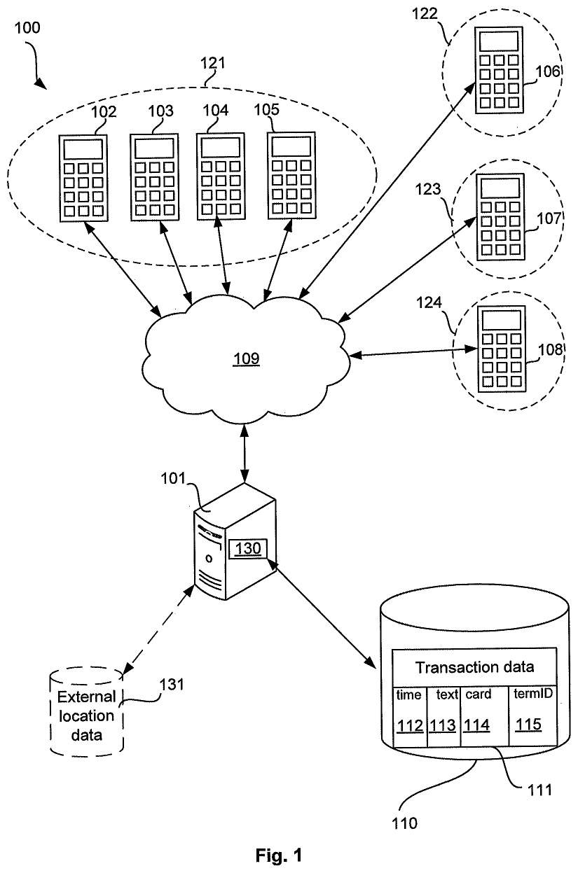

FIG. 1 is an example illustration of computer network 100 comprising a server 101 and multiple POS terminals 102-108. As customers use their payment cards, terminals 102-108 send transaction data through a payment network 109 for settlement with respective banks. While examples herein relate to payment cards, such as credit cards or debit cards, it is noted that other payment objects may be used, including mobile phone payments as long as there is a physical payment object (i.e. card or phone) that the consumer presents to the terminals 102-108. Server 101 receives the transaction data either from banks or directly through the payment network 109 and stores the transaction data in a transaction database 110. For example, server 101 maintains a data table 111 with data fields for transaction time 112, terminal text 113, payment object ID 114 and terminal ID 115.

The aim is now to determine a location for a particular terminal, which is referred to herein as the subject terminal. In this example, terminal 102 is the subject terminal. Of course, the methods described herein can be repeated for multiple or all terminals 102-108 to determine respective locations. In the example of FIG. 1, terminals 102-105 are located at a first location 121, while terminal 106 is located at second location 122, terminal 107 at third location 123 and terminal 108 at fourth location 124 as indicated by dashed ellipses. In one example, locations are suburbs or postcodes which means that the terminals 102-105 are relatively close to each other while they are relatively far away from terminals 106-108.

As noted above, the terminal text of subject terminal 102 may provide some indication of location 121 but often that information is not sufficiently accurate or even incorrect. However, it is possible to infer a location of subject terminal 102 using terminal texts from other, non-subject terminals 102-105. While the terminal texts from non-subject terminals are generally also inaccurate, the accuracy can be improved by taking multiple texts in combination and inferring the most likely location for subject terminal 102. At this point, it is important to note that at the outset it is not known that terminals 102-105 are at the same location or nearby locations but the methods describe herein will combine indications from the respective terminal texts to determine locations. To that end, server 101 analyses the transaction time 112 and concludes that transactions using the same payment object 114 and within a short time, are likely made at nearby locations. Therefore, terminal texts from those terminals are likely to indicate the same location, such as the same suburb. Again, the methods disclosed herein consider multiple different, potentially inaccurate or incorrect, terminal texts from allegedly nearby terminals and combine them to determine an accurate location of the subject terminal 102 and potentially the nearby terminals 103-105.

The server 101 further includes a communications module 130. Communications module 130 may comprise one or more of a TCP/IP, HTTP/HTTPS, Wi-Fi, Bluetooth, USB, Ethernet, or other communications modules, configured to allow server 101 to communicate with the transaction data database 110. The server 101 may communicate directly with the subject point of sale terminal using similar means, but the server may, in addition or alternatively, retrieve data generated by the subject point of sale terminal 102 from the transaction database.

In this example, the server 101 identifies a subject terminal 102 from the transaction data 111. The subject terminal 102 is a terminal that can be identified by the terminal id 115 in the transaction data or from a similar form of identification.

According to some embodiments, terminals 102-108 are physical points of payment that are generally fixed for at least a period of time, such as one week, or for at least a significant number of payment transactions, such as 1,000, which may be the case for concerts or events at temporary locations. In some embodiments, a terminal is mobile such as a handheld EFTPOS or credit card device and in other embodiments it could be a mobile phone or a tablet. POS terminals may also by integrated with computers such as using a USB card reader.

Then the server 101 determines one or more payment objects 114 from the transaction data 111. In some embodiments, a payment object 114 may be a credit card, loyalty card or mobile phone. Generally the payment object 114 is a physical object. Functions of the payment object are explained in further detail below, but generally a payment object is any way of initiating a transaction that restricts the ability or likelihood of consecutive transactions being made at geographically separated terminals within a determined amount of time that is reasonable for the distance of separation.

The server 101 then collects one or more other transaction data of the subject terminal 102 based on a payment object 114. The transaction data is typically the data in the transaction data database 110 that has been generated by multiple point-of-sale terminals 102-108 performing multiple transactions over a period of time. Typically, the transaction data is a log of all the terminal transactions which can be useful if there is an error in the payment network or if a transaction is disputed by a customer.

Once the transaction data 111 has been collected, the server 101 determines one or more candidate locations of the point-of-sale terminal based on the transaction data and the textual terminal descriptor.

The server 101 then determines the estimated location 121 of the point-of-sale terminal 102 based on the one or more candidate locations of the point-of-sale terminal. In some embodiments, the server 101 may also determine the likelihood of the estimated location being the actual location of the terminal.

### Method for Determining a Location

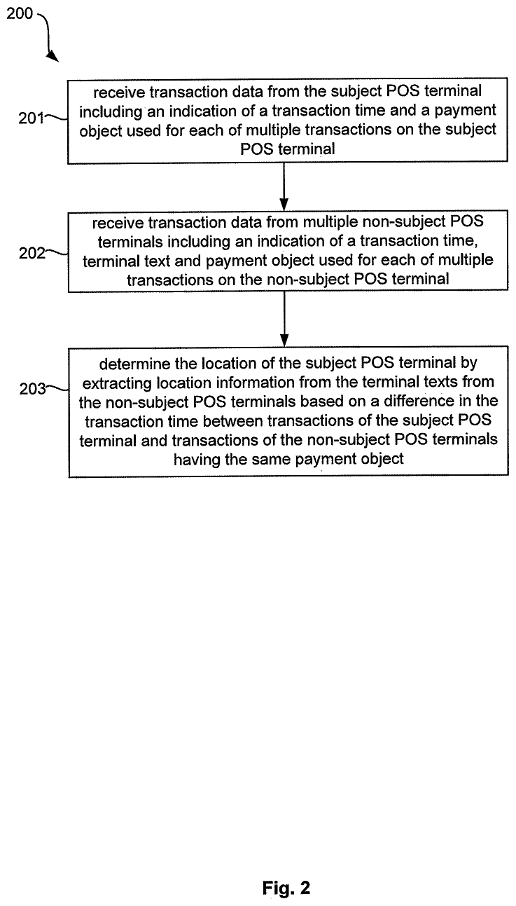

FIG. 2 illustrates a method 200 for determining a location of subject point-of-sale terminal 102. The method is performed by server 101, which first receives 201 transaction data from the subject POS terminal including an indication of a transaction time and a payment object used for each of multiple transactions on the subject POS terminal. The transaction time may include a date and time and receiving the transaction data may comprise requesting the transaction data from database 110, such as through an SQL query, and receiving the data in a response. Receiving the transaction data may further comprise receiving the data from another server, storing the data in database 110 and then performing the methods disclosed herein as part of a single or multiple SQL statements.

Server 101 similarly receives 202 transaction data from multiple non-subject POS terminals 103-108 including an indication of a transaction time, terminal text and payment object used for each of multiple transactions on the non-subject POS terminal. It is noted that the indication of a payment object may be a credit card number or account number of the customer. It is further noted that steps 201 and 202 may be performed in a single query.

Finally, server 101 determines 203 the location of the subject POS terminal 102 by extracting location information from the terminal texts from the non-subject POS terminals. This is based on a difference in the transaction time between transactions of the subject POS terminal and transactions of the non-subject POS terminals having the same payment object. In other words, if a customer uses the same payment object twice, the time difference between those two transactions can be used to determine whether the transactions (i.e. the corresponding terminals) are in close proximity. Importantly, server 101 uses this time difference information to extract location information from the terminal texts. By combining the time difference with extracting location information in the same process, it is possible to infer locations even in cases where the accurate location of all terminals is unknown. This is in contrast to other approaches that use known exact locations of nearby terminals from the outset.

One example is described in more detail below, where server 101 creates pairs of transactions with the same payment object and tokenises the terminal texts to extract multiple candidate locations for each terminal. Server 101 then ranks the multiple candidates by plausibility using the time difference as a distance indicator. Server 101 then selects the most plausible location for the subject POS terminal.

### External Location Information

The server 101 may in some embodiments have access to external location information 131. External location information 131 includes merchant address information for merchants that can be linked to terminal ids. For example, a merchant address file supplied by a bank from the data that they hold on their merchants. Additional external location information may include address information derived by combining the identified brand with identified location information cross checked against an alternative source. For example, combining the identified brand of “Woolworths” with the identified suburb of “Neutral Bay” and cross checking that combination on the public facing website of Woolworths to determine the exact address. Other external location data may be a location associated with the payment object or consumer, which for example, may be the suburb of a consumer based on their address, supplied by the bank.

### Payment Object

A payment object is an object that is used for payment. Typically this is associated with the method of payment at the terminal. For example, a credit card method of payment will typically be associated with a credit card number, where the credit card is a payment object. Other examples of payment objects include debit cards, loyalty cards, smart cards, and near field communication (NFC) devices such as a smart phone.

A payment object, typically being a physical object such as a card is assumed to be either unique or effectively unique. That is, a payment object such as a credit card only exists in the cardholder's wallet or purse and therefore can only be used in one location at one point in time. This contrasts against, for example, internet transactions, which do not require the user or payment object to be physically present. In some cases, the payment object may be able to be used without being physically present (such as a credit card on the internet) in which case the transaction data may indicate whether the card is present.

Therefore, in a broader sense, a payment object can be any way of initiating a transaction that restricts the ability or likelihood of consecutive payments being made at geographically separated terminals within an amount of time that is reasonable for the distance of separation between the terminals. That is, where a payment object is present in multiple transactions the time discrepancy between uses of the payment object would need to be consistent with the distance between the terminals at which the payment object was used. For example, a physical card or phone will be carried by a person and therefore can not be used for transactions at a terminal in Sydney and then for a transaction in Melbourne less than an hour later.

### Terminal

A terminal 102-108 is a physical point of payment. These can be mobile but are most commonly used at a fixed location.

### Location

A location is a position on the surface of the earth. This is often taken to be a point such as a combination of latitude and longitude but could be an area such as a town, region, suburb, zone or precinct. Candidate locations are the candidates for the estimated location of the subject terminal 102 based on the locations of the non-subject terminals. An estimated location is an estimate of the location of the subject terminal 102.

### Terminal Text

In many banking systems, a terminal is associated with a short description and often with a limited number of characters. This is referred to in this disclosure as the terminal text 113. The terminal text 113 is typically provided in an entry in a transaction database 110 and is therefore accessible in the transaction data. The terminal text is usually identical for all transactions for a given payment method at a given terminal, but can change over time as terminals are reused for different purposes.

### Transaction Data

The transaction data 111 is the data generated by transactions. Generally, the transactions are consecutive some of which have been made by the same payment object. In some cases, the transaction may be made by the same consumer or some other form of grouping but it is generally possible to strip out transactions that do not relate to the same payment object.

### Extended Example

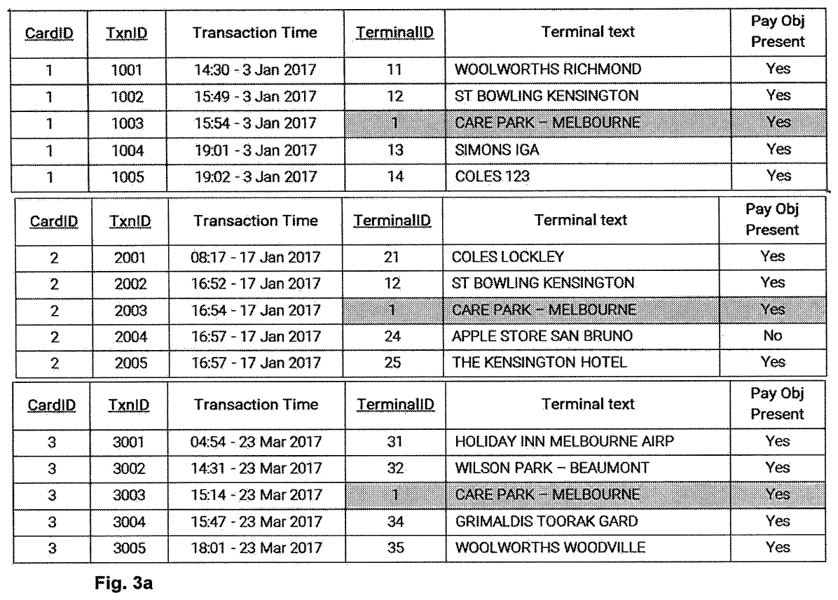

The following description provides an extended example that explains method 200 in more detail. FIG. 3a and FIG. 3b illustrate example transaction data collated by payment object according to steps 201 and 202 of method 200. In this example, the payment object is a credit or debit card, which is associated with a unique card identifier. FIG. 3a shows the transactions with the cards 1, 2 and 3 (that is, those cards with an identifier 1, 2 and 3). Card 1 has transactions 1001, 1002, 1003, 1004 and 1005. Card 2 has transactions 2001, 2002, 2003, 2004, 2005. Card 3 has transactions 3001, 3002, 3003, 3004, 3005.

FIG. 3b shows the transactions with the cards, 4 and 5 (that is, those cards with an identifier 4 and 5). Card 4 has transactions 4001, 4002, 4003, 4004, 4005. Card 5 has transaction 5001, 5002, 5003, 5004, 5005.

Each of the five cards 1, 2, 3, 4, 5 have a transaction at terminal 1, which is the subject terminal 102 for this example. For each transaction at terminal 1, the terminal text is “CARE PARK-MELBOURNE” and the payment object is present at the time of the transaction. However, it is worth noting that the payment object is not present for transaction 2004. Transaction 2004 is a transaction at a non-subject terminal with a terminal id 24.

Create Transaction Pairs for the Subject Terminal and a Non-Subject Terminal from the Same Payment Object

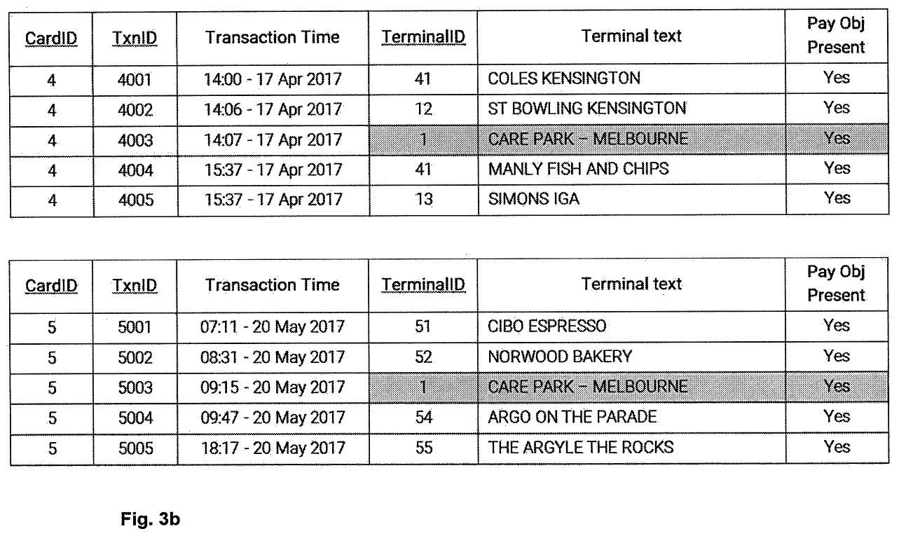

FIG. 4 illustrates a table by which the subject terminal has been paired up with a non-subject terminal from the same payment object. In other words, server 101 creates multiple pairs of transactions and each pair comprises one transaction of the subject POS terminal by a payment object and one transaction of one of the multiple non-subject POS terminals by the same payment object. For example, TransactionID=1003 has 4 other transactions from the same payment object, namely those with TransactionIDs 1001, 1002, 1004 and 1005. There are 4 for transaction CardID=2, etc. The terminal text in FIG. 4 is the terminal text of the non-subject terminal, because, as above, the terminal text of the subject terminal does not change.

A customer making n transactions would have

$$\frac{n \times ( n + 1 )}{2}$$

transaction pairs, which quickly grows to a number of pairs that are difficult to process with existing computer hardware. Therefore, there may be optimisations that can be made. One such optimisation can be to only consider the transaction pairs where there is less than 2 transactions between the transactions in each pair in the temporal sequence of transactions by that one payment object. This can be expressed as the formula:

|TransactionId(Subject terminal)−TransactionID(non-subject terminal)|<k;k=2

As an example, the transactions at the subject terminal are 1003, 2003, 3003, 4003, and 5003. This optimisation would mean discarding pairs for transactions after 1005, 2005, 3005, 4005, 5005, and correspondingly before 1001, 2001, 3001, 4001, 5001 because these transactions in relation to the transactions at the subject terminal have 2 or more transactions in between.

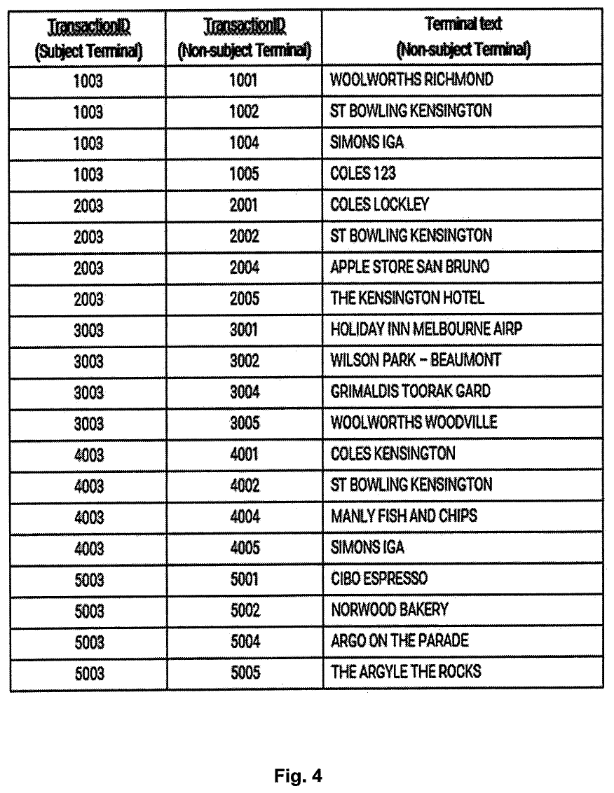

In the above example of FIG. 4, transactions where the payment object is not present can be excluded because they could have been made from any location such as via any internet connected device. The result is shown in FIG. 5. By excluding these transactions they will be treated as if they never occurred. For example, as described above, the transaction 2004 did not have a payment object present, so in this example the transaction 2004 can be excluded at it has been made online with the card not being presented for the purchase.

### Determine Time Difference Per Transaction Pair

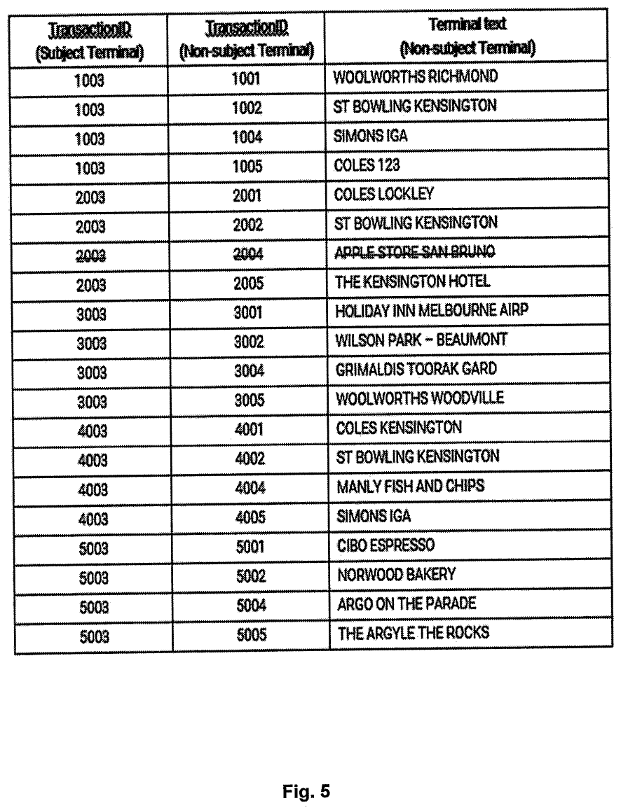

Once transactions that do not have a payment object present have been excluded, for each transaction pair a time difference can be calculated as mentioned in relation to step 203 of method 200. FIG. 6 shows the resulting time differences. That is, each transaction pair comprises a subject terminal transaction and a non-subject terminal transaction. These transactions have a time at which the transaction took place. The time difference is calculated to be the difference in time of the subject terminal transaction before or after the non-subject terminal transaction. This time difference will be utilized to determine a likelihood that a non-subject terminal is nearby the subject terminal. Server 101 will then extract location information from the non-subject terminal text based on the time difference.

### Filter and Order Transaction Pairs

In order to provide a set of transaction pairs that will provide useful information about the subject terminal, it can be possible to apply filters to the pairs so that certain types of information can be disregarded. This may be to remove redundant information about a terminal, or to reduce the total number of pairs.

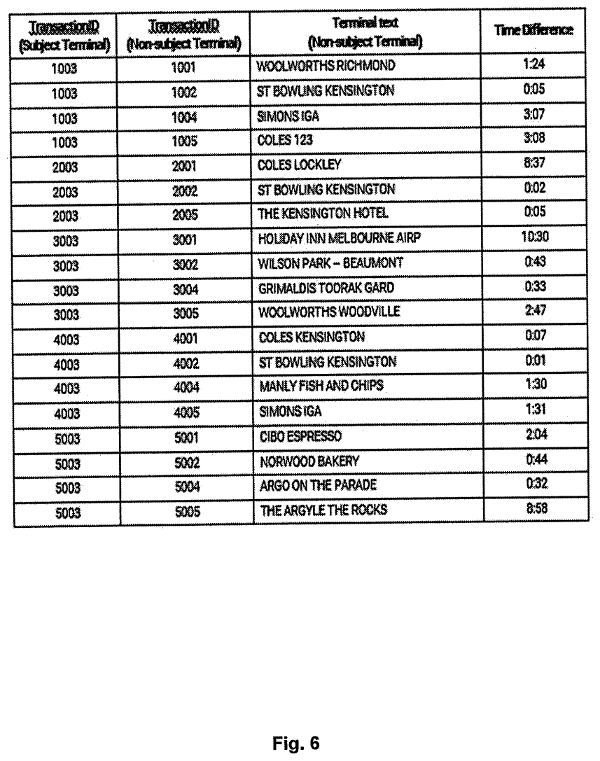

In the example of FIG. 7, server 101 has ordered the rows in the table of FIG. 6 by time difference and subsequently applied the following rules to filter the transactions. In practice the parameters can be set to suit the data or the amount of data that is generated.
1. Remove the 3rd or more transactions from the same nearby terminal in the first 5 transactions
2. Remove the 3rd or more transactions from the same brand
3. Remove the 2nd or more transactions per terminal after transactions 5
4. No more than 15 transactions in total

In the example of FIG. 7, the following transactions can be removed due to these filters:
Row 3—3rd transaction pair at the same terminal in the top 5 transactions (Rule 1)
Row 15—2nd transaction pair for this terminal (Rule 2)
Row 18—3rd transaction pair for the brand Coles (Rule 3)
Row 19—16th transaction (Rule 4)

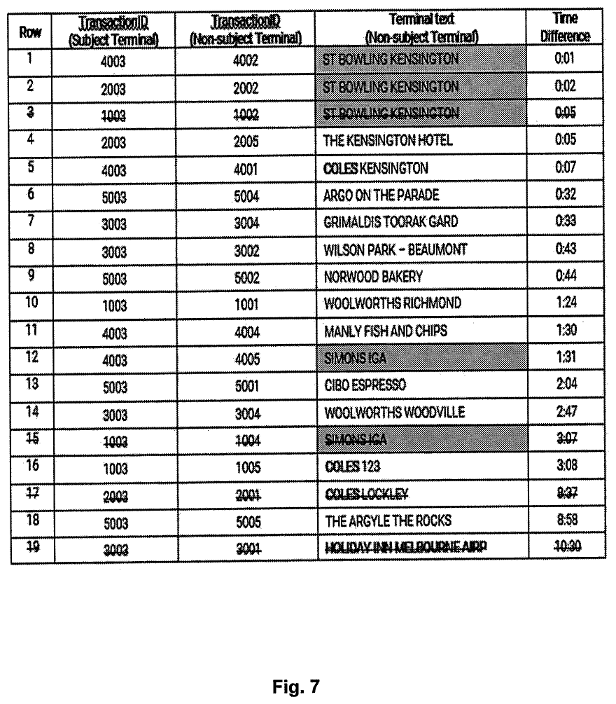

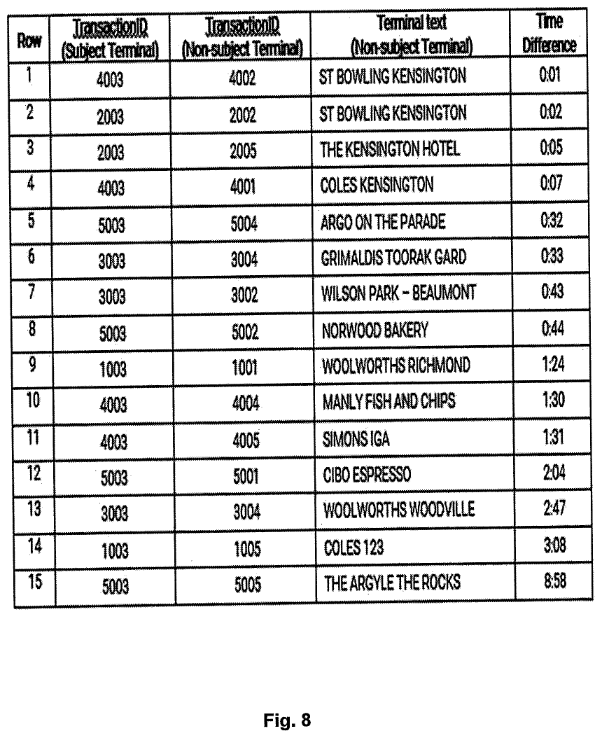

FIG. 8 illustrates the location pairs after the above rows have been removed. The next step in this extended example is to add a special transaction pair for the subject terminal. This is illustrated as the first row in the table of FIG. 9. This transaction pair is special because there is no corresponding non-subject terminal for the subject terminal. This special transaction pair can be used as a reference point against which the other transaction pairs are compared.

### Add Weights for Transaction Pairs

Server 101 can add weights to each of the transaction pairs. In this example, the special transaction pair of the subject terminal is given a weight of 4, and the remainder of the transaction pairs are given a weight of 1. Note that this weight w is an input parameter that can be set to any positive number. The algorithm would work the same way with any other weight, but a higher weight would mean that the estimated location of the subject terminal would be more heavily influenced by the terminal's terminal text. In practice, a weight around 16 seems to be ideal, but 4 is used here for illustrative purposes.

### Tokenisation of Terminal Text

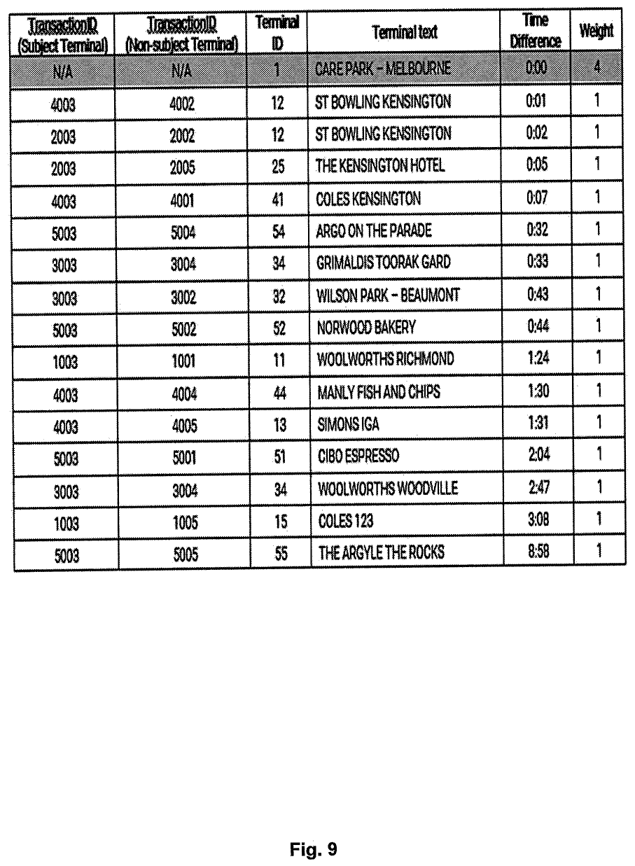

For each terminal text, server 101 performs natural language processing. One form of natural language processing is called tokenization, which is a process of breaking a stream of text up into words, phrases, symbols, or other meaningful elements called tokens. In this case, the terminal text can be parsed to identify location related tokens. FIG. 10 is an illustrative example of how the tokenisation of terminal text may be applied.

### Match Tokens to Known Locations

Each token in the terminal text can be matched to a known location. The known locations may include places, locations, suburb names, cities, towns, known store locations, ATM locations or other geographical indicators. The known locations may be stored in a separate database such as the external location data 131.

In a more general sense, this part of the process involves determining an identifier of a geographical area from the textual terminal descriptor, and then matching the identifier of the geographical area with the geographical area in a knowledge base database.

Matching tokens may be implemented to occur in multiple ways. Match types include the following:
a. Exact: the token matches a known location exactly. For example, the token ‘Beaumont’ matches the suburb Beaumont exactly.
b. Starts-with: the token matches a specified number of letters in a known location. For example the token ‘Beaum’ matches the suburb Beaumont, as it starts with the first five letters of the suburb. In this extended example, five letters is the parameter used for a starts-with match. This parameter can be increased or decreased depending on the tolerance for false-positive or true-negative location results.
c. Regex: regex expressions are well known in natural language processing. As an example, the regex expression ‘Beau.*’ matches with the suburb Beaumont.
d. Other suitable matching techniques known to those skilled in the art.

Importantly, server 101 not only considers exact matches of the entire terminal text but also exact matches of substrings represented by the tokens as well as partial matches under b and c. As will be described further below, server 101 extracts location information based on the time difference between transactions by ranking the matched tokens based on the time difference in the corresponding pair.

Match Tokens to Word Position within the Terminal Text

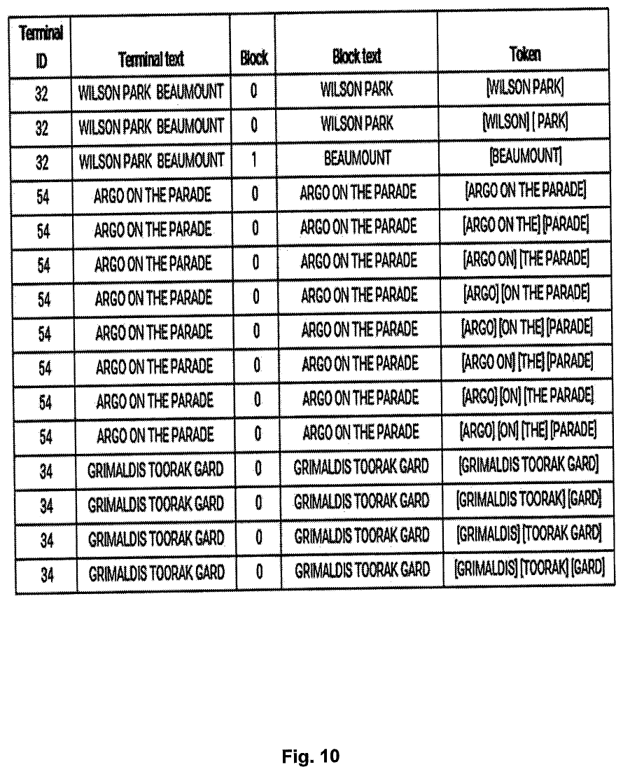

FIG. 11 illustrates how matches of tokens can operate. Each entry in the table represents a different token which can be used to match against a known location. The position of the token that has matched to the known location within the terminal text is also of importance, because some terminal texts contain multiple locations.

In this example, the word position is expressed as a three-digit number. The first number indicates the block where the location name is found. For example, all the terminal texts above only contain one block, except for “WILSON PARK BEAUMOUNT”. The last two digits indicate the word number (starting at index 0) of the suburb name within the block. For example, the terminal text and word positions can be broken down by position as follows:

| a. terminal text: | word1 | word2 | word3 | word4 |
|---|---|---|---|---|
| b. Word positions: | 100 | 101 | 200 | 201 |

The next step is to determine a list of locations for each terminal text. For each terminal text there is one or more potential token matches to location tokens. Each of these location tokens will have one or more potential locations attached to them.

### Collate Locations for Each Terminal Text

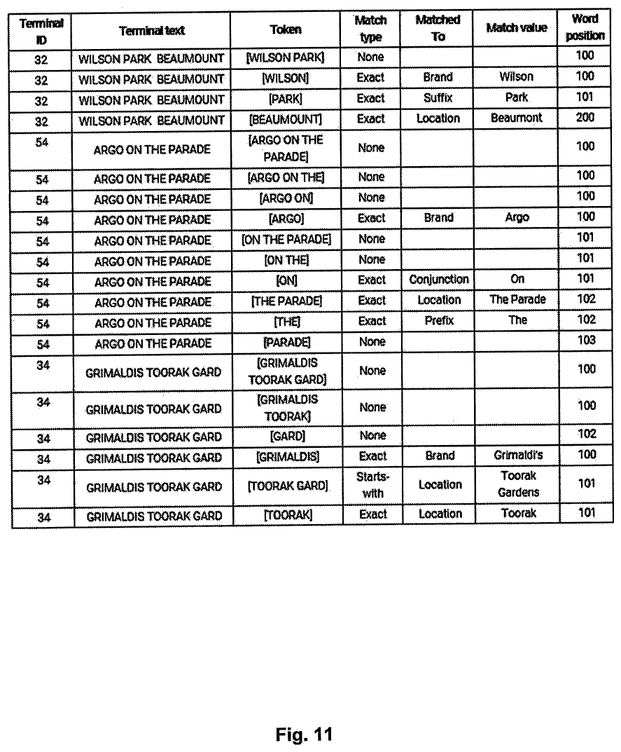

In the example of FIG. 12, all the locations for each terminal text are collected. The matches at the same point are collapsed to a preferred match. In the case of the “ARGO ON THE PARADE” the location and match position are identical and are collapsed to a single match. For the “GRIMALDIS TOORAK GARD” case there are two potential options for location 101. The first option proposes Toorak from the text “TOORAK” and the other proposes Toorak Gardens from the text “TOORAK GARD”. In this situation the match with the longer location name is selected (Toorak Gardens) and all other matches discarded.

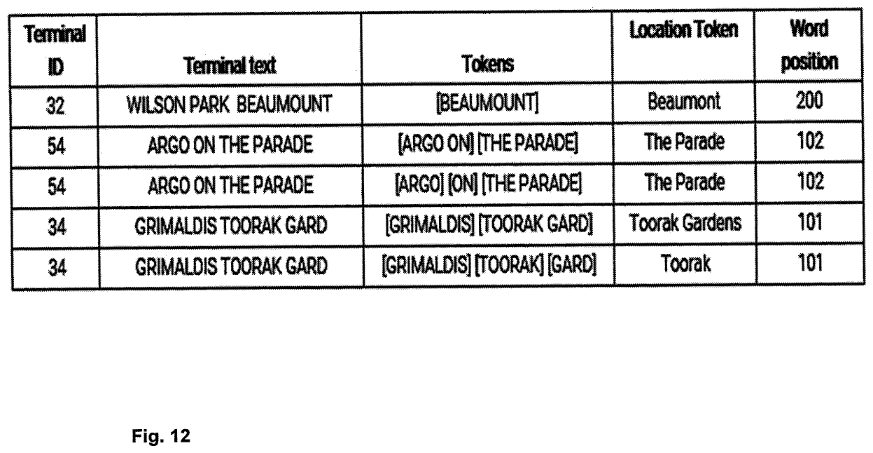

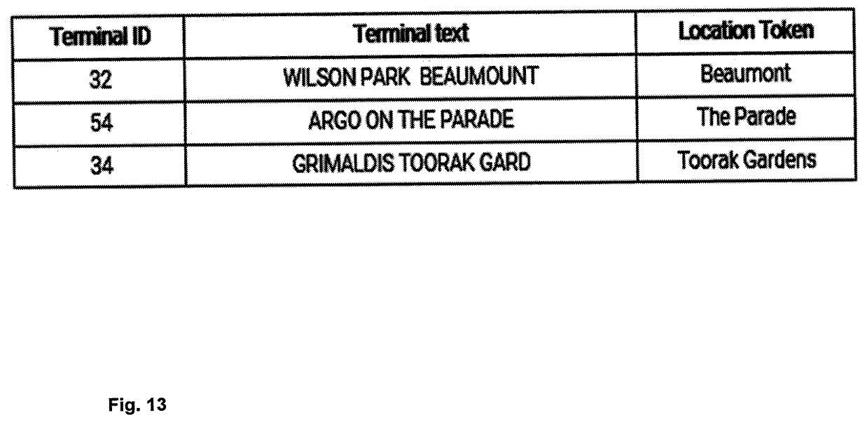

FIG. 13 shows the result from the example in FIG. 12 where the matches described above have been discarded. The locations associated with each location token are illustrated in the example in FIG. 14. This can be one or more item and includes a latitude and longitude or a definition of an area. In this example latitude and longitude are used.

While the list of potential locations in this example in FIG. 14 is short, in practice they can be much longer. A terminal text “COLES SPRINGFIELD” would produce a list of 9 locations as “Springfield” matches to 8 different suburbs within Australia and “Coles” is also a suburb. In practice, there may be additional rules or heuristics that can be used to reduce the potential list of locations or to eliminate clearly incorrect locations.

### Determine List of Potential Locations Per Terminal

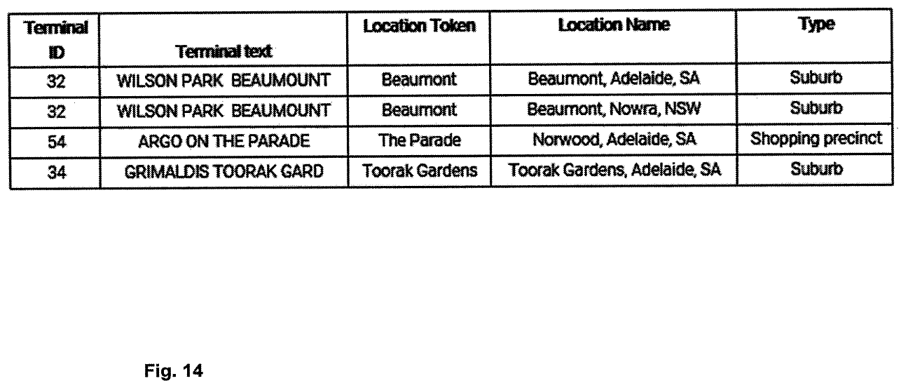

The next step is to determine a list of potential locations for each terminal. FIG. 15 shows the outcome of this step. In this example, the table is list of potential locations for the subject terminal generated from the subject terminal itself, plus any potentially nearby terminals. For illustrative simplicity, only 6 potential locations are used but in practice there could be many more. Each potential location has a corresponding latitude and longitude which is used in the following steps.

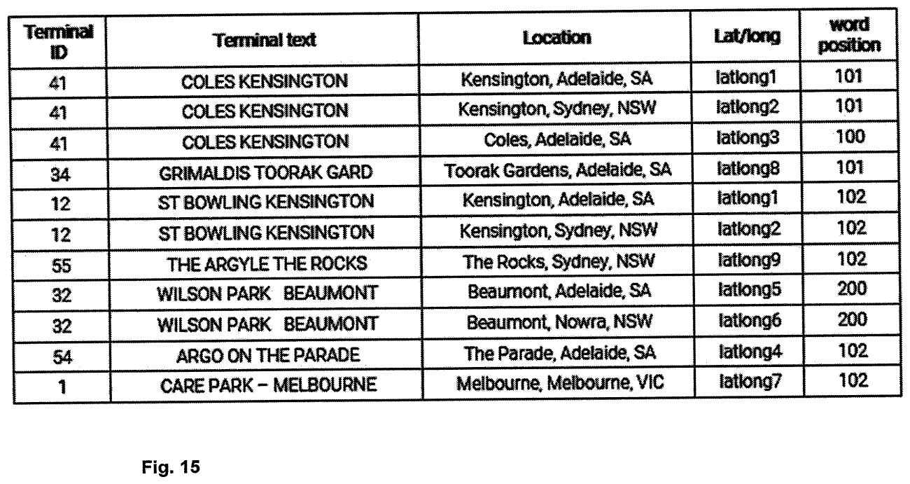

The candidate locations are then combined with the output from FIG. 9, which creates an expanded list of each transaction associated with the subject terminal. This data has the time differences and weight as well as each corresponding potential location associated with each transaction. The first 12 records of the results of this step are shown in FIG. 16.

### Create Candidate Locations by Selecting Potential Locations

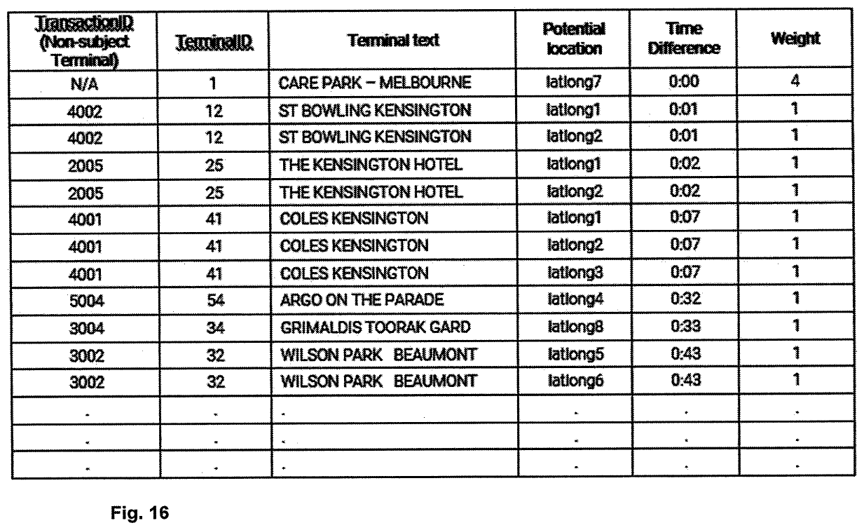

The next step is to create candidate locations for the subject terminal by selecting potential locations of the non-subject terminals. In this example, this involves creating a record for each potential location. The records for FIG. 16 are repeated for each candidate location, although it is to be noted that for simplicity only a small subset of the total records have been illustrated in FIG. 17.

### Plausibility Calculation

Once the candidate locations have been created, each candidate location can be compared with the potential location to determine a score of the candidate location based on the corresponding time difference. This score may be produced by a plausibility function.

An example plausibility function would be as follows:
1. Calculate the haversine distance between the two suburb centroids.
2. Multiply the distance by 1.3 to allow for the fact that travel usually does not occur in a straight line, but rather via the road network which is not necessarily linear.
3. Assume that one travels at 5 km/h for the first 500 m, 60 km/h for the next 5 km and 110 km/h for the remainder of the journey.
4. Compare the actual time difference with the result from step 3. If the journey was plausible in the allotted time, assign a 1. If the journey was not plausible, assign a 0.

Note that step 1 in this example plausibility function utilises suburbs. A similar calculation at step 1 could be made with two points, a point and a suburb or other combinations of locations. In such cases, a different multiplication factor at step 2 may be used.

In some cases, the heuristic assumptions at step 3 can be modified. For example, potential locations surrounding airports or train stations may have additional or alternative assumptions regarding travel time.

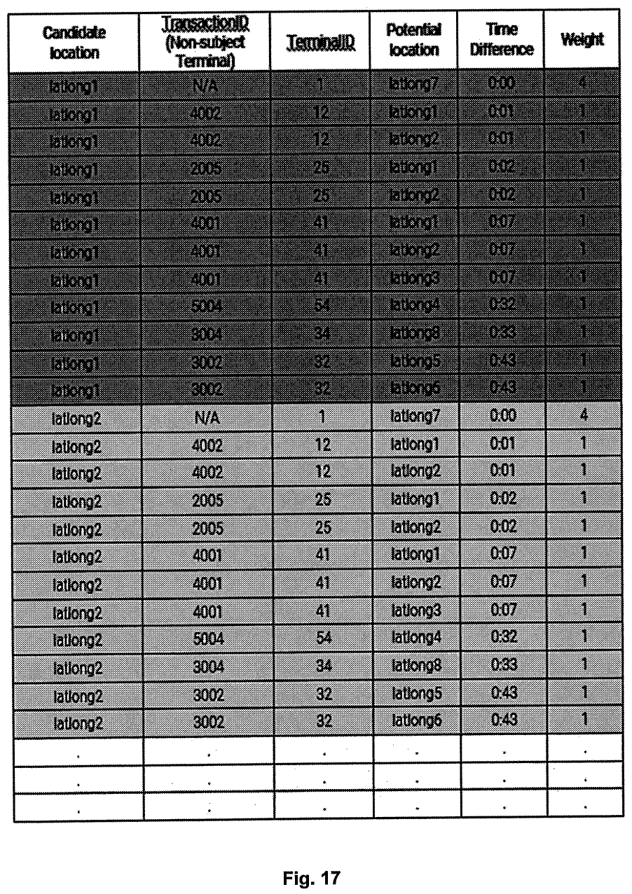

The resulting plausibility calculations are shown in FIG. 18. As can be seen, each candidate location record is assigned a value, which is the result from the plausibility function. In this example, the plausibility function is the example plausibility function described above. However it is to be understood that many different plausibility functions can be used for this calculation.

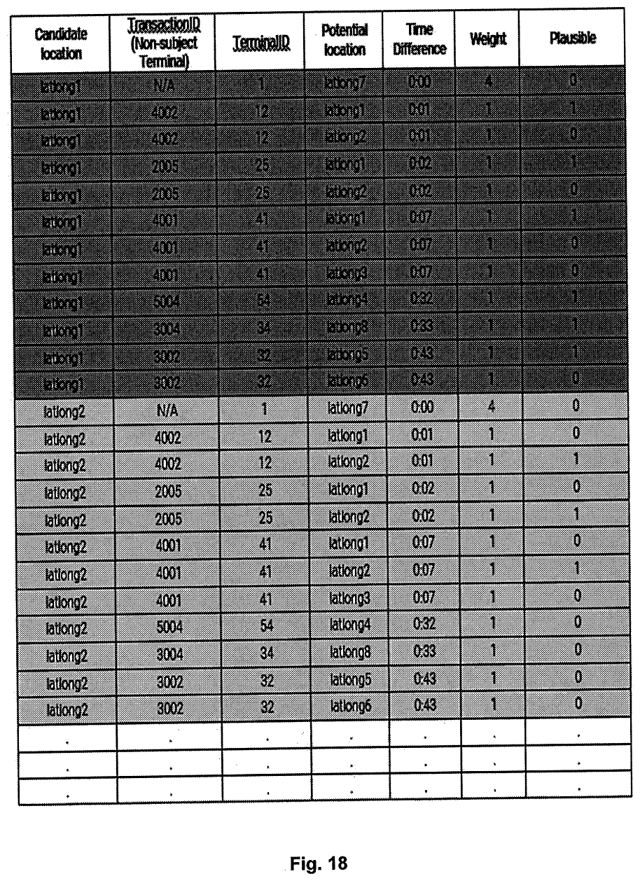

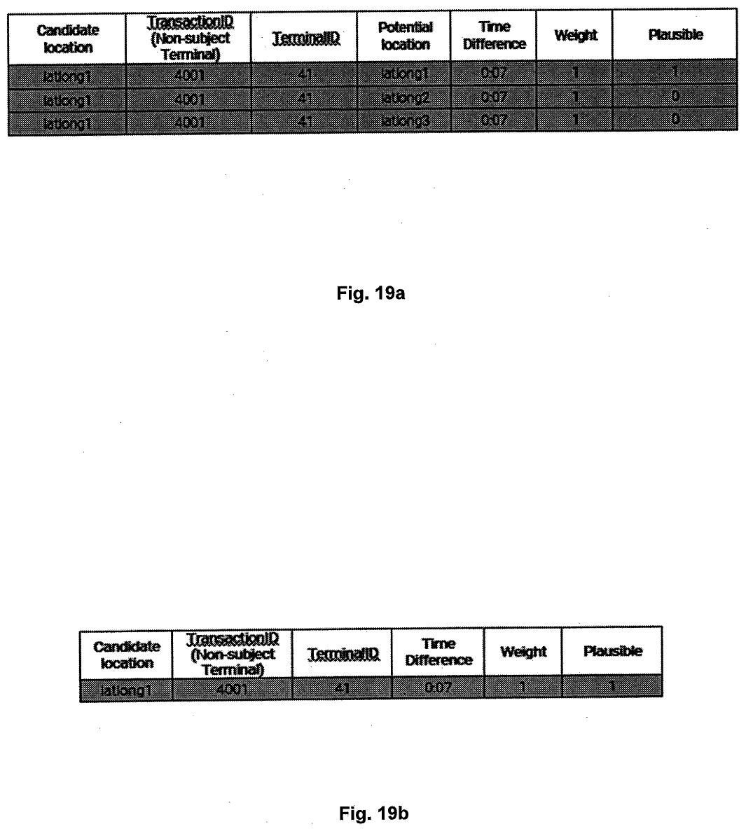

The combinations of candidate location and transaction id can then be collapsed into a single record. In this example, the plausibility flag of 0 is set if the corresponding records for each combination of candidate location and transaction is 0. That is; for a combination of candidate location and transaction id to be implausible, all the combinations must be implausible. FIG. 19a and FIG. 19b illustrates an example of this. Here the records for candidate location of ‘latlong 1’ and transaction id ‘4001’ in FIG. 19a are collapsed into a single record in FIG. 19b with plausibility flag of 1, because one of the records in FIG. 19a has a plausibility flag of 1 even though the other two records have flags that are 0. FIG. 20 illustrates the resulting table such that each of the potential locations have been reduced to a single candidate location per transaction ID.

### Calculate Plausible Weight of and Average Plausible Time Difference

The next step is to calculate plausible weight of and average plausible time difference. That is, for each candidate location the proportion of the weight that is plausible is calculated, along with the average plausible time difference.

These calculations are according to the formulas as follows:

$$Plausibility weight = \frac{\sum plausible \times weight}{\sum weight}$$

$$Average plausible time difference = \frac{\sum plausible \times weight \times time difference}{\sum weight} .$$

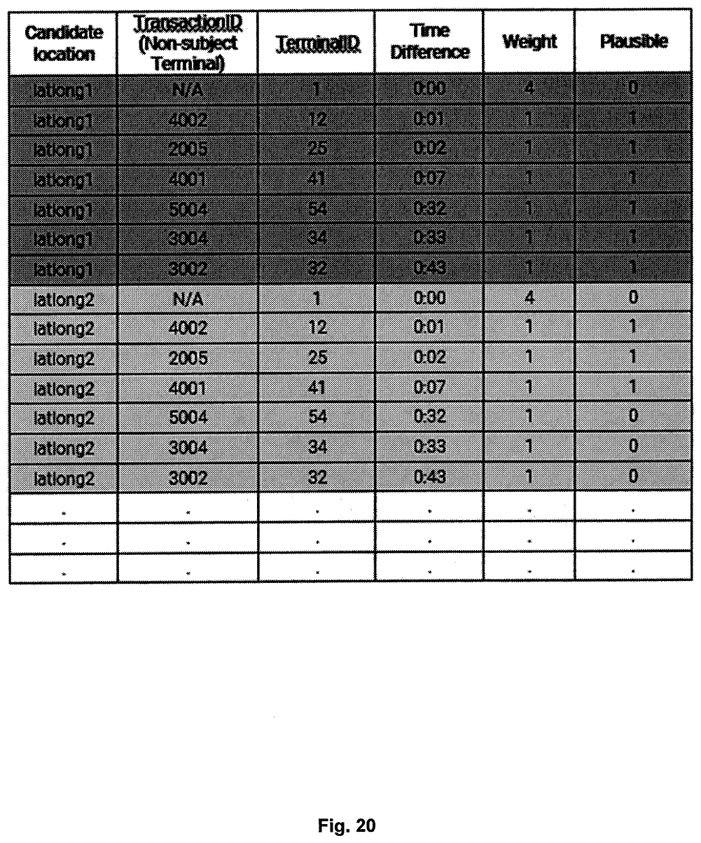

FIG. 21 illustrates the plausibility weight and average plausible time difference calculated per combination of candidate location and transaction ID. As can be seen in this example, the candidate location of ‘latlong1’ has a plausibility weight of 6/10 and an average plausible time difference of 19 seconds. The candidate location of latlong2 has a plausibility weight of 3/10 and an average plausible time difference of 3 seconds.

Determine Estimated Location from the Candidate Locations

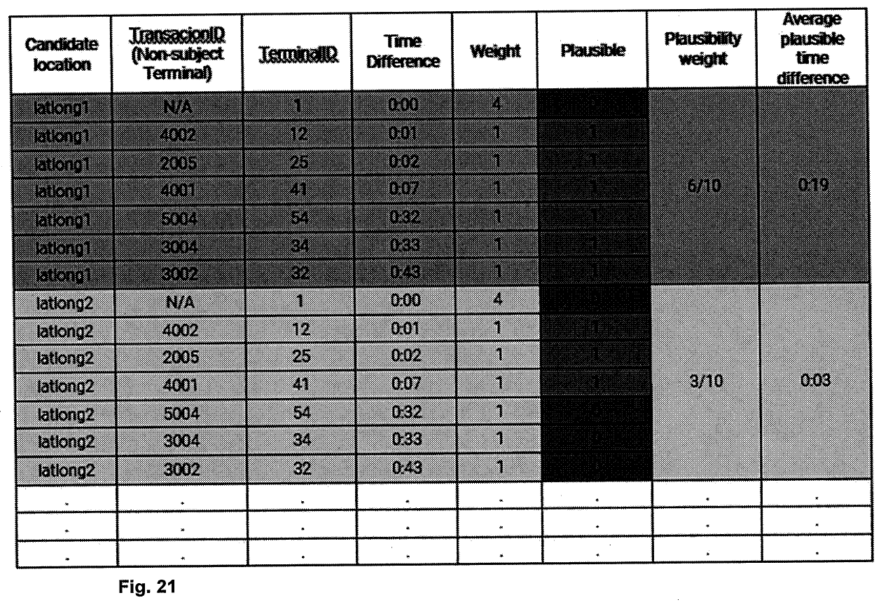

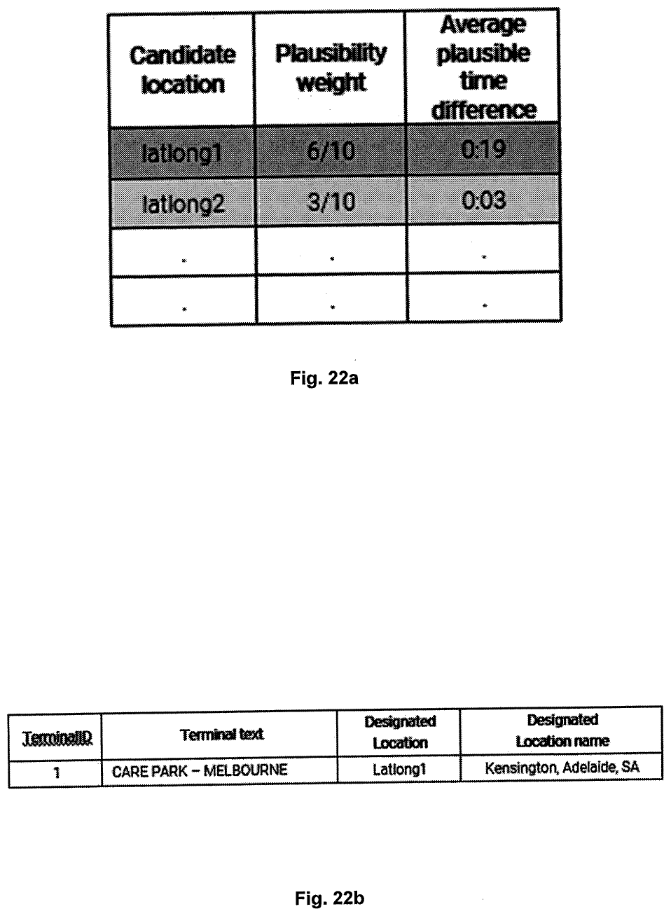

The final step is to determine an estimated location from the list of candidate locations. FIG. 22a illustrates the table in FIG. 21 but where there is a single record per candidate location maintaining the corresponding plausibility weight and the average plausible time difference.

In this example, an estimated location for the subject terminal can be determined by ordering the candidate locations by decreasing plausibility weight and increasing average plausible time difference and taking the top record. If there are more than one record with the same plausibility weight and average plausible time difference, then the candidate location with the highest word position value (from FIG. 15) is selected.

For this example, the subject terminal that has terminal text of “CARE PARK-MELBOURNE” is estimated to be in a location in a different part of the country to what would be reasonably presumed by looking at the terminal text alone, as displayed in FIG. 22b.

### Example Method

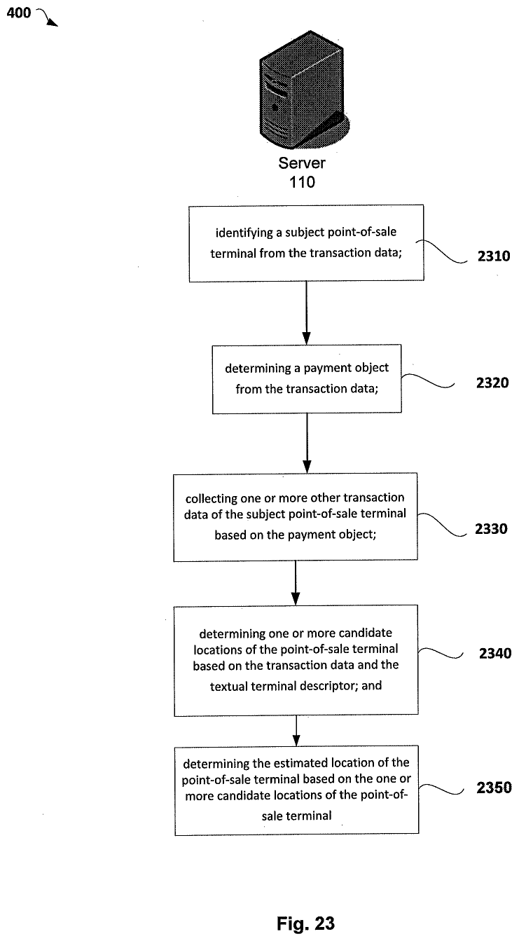

FIG. 23 illustrates another example of method 200 performed by a server 110 from a different viewpoint. The first step of the method involves identifying 2310 a subject point-of-sale terminal from the transaction data. Next is determining 2320 a payment object from the transaction data. Once the payment object is determined, the server 110 can collect 2330 one or more other transaction data of the subject point-of-sale terminal based on the payment object. The server 110 can then determine 2340 one or more candidate locations of the point-of-sale terminal based on the transaction data and the textual terminal descriptor and finally determine 2350 the estimated location of the point-of-sale terminal based on the one or more candidate locations of the point-of-sale terminal.

### Example System

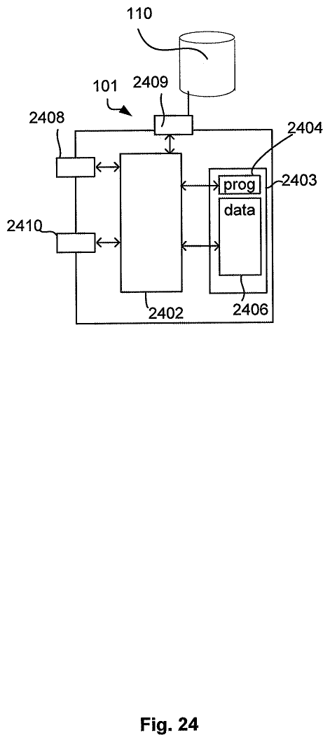

FIG. 24 illustrates an example server 101. The server 101 shown in FIG. 24 includes a processor 2402, a memory 2403, and network interface devices 2408, 2409, 2410. Network interface device 2408 may interface with the subject terminal. Network interface device 2409 may interface with the transaction data database 130. Network interface device 2410 may interface with the external location data database 170. The memory 2403 can store instructions 2404 and data 2406 and the processor 2402 can perform the instructions from the memory 2403 to implement the processes as described in FIG. 2 and FIG. 23.

Processor 2402 can determine an instruction. The instruction may be a function to execute. The processor 2402 may execute instructions stored in the program code 2404 to indicate any output.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for determining a location of a subject point-of-sale (POS) terminal, the method comprising:
receiving transaction data from the subject POS terminal including an indication of a transaction time and a payment object used for each of at least one transaction on the subject POS terminal;
receiving transaction data from at least one non-subject POS terminal for at least one transaction with the payment object, the transaction data including an indication of a transaction time, terminal text and payment object used for each of the at least one transaction on the non-subject POS terminal;
determining the location of the subject POS terminal by extracting location information from the terminal texts from the at least one non-subject POS terminal based on a difference in the transaction time between the at least one transaction of the subject POS terminal and the at least one transaction of the non-subject POS terminal.

2. The method of claim 1, comprising:
receiving transaction data for at least one transaction with the payment object from multiple non-subject POS terminals; and
determining the location of the at least one non-subject POS terminal by extracting location information from the terminal texts from multiple non-subject POS terminals based on a difference in the transaction time between the at least one transaction of the subject POS terminal and the at least one transaction of the multiple non-subject POS terminals.

3. The method of claim 1, wherein the transaction data from the subject POS terminal includes an indication of transaction time and one of multiple payment objects used for each of multiple transactions on the subject POS terminal, and wherein the transaction data from the at least one non-subject POS terminal includes an indication of transaction time, terminal text and one of multiple payment objects used for each of the multiple transactions on the at least one non-subject POS terminal.

4. The method for determining the location of a subject POS terminal of claim 2, wherein determining the location of the subject POS terminal further comprises updating the location using the transaction data from transactions with the payment object from the multiple non-subject POS terminals.

5. The method for determining the location of a subject POS terminal of claim 3, wherein determining the location of the subject POS terminal further comprises updating the location using the transaction data from the at least one non-subject POS terminal using different payment objects.

6. The method of claim 1, further comprising:
creating multiple pairs of transactions, each pair comprising one transaction of the subject POS terminal by a payment object and one transaction of one of the multiple non-subject POS terminals by the same payment object.

7. The method of claim 6, wherein creating the multiple pairs of transactions comprises creating only those pairs of transactions where the transactions are not more than a threshold number of transactions apart from each other in a sequence of transactions by that payment object.

8. The method of claim 6, further comprising excluding transactions where a payment object was not present.

9. The method of claim 6, further comprising calculating a time difference between the transactions of each of the multiple pairs of transactions and determining the location of the subject POS terminal based on the time difference.

10. The method of claim 9, further comprising one or more of:
removing pairs with transactions over a first threshold number of transactions of the same non-subject POS terminal;
removing pairs with transactions over a second threshold number of transactions of the same brand as identified from the terminal text;
removing pairs with transactions over a third threshold number of transactions per terminal after a fourth threshold number of transactions;
removing pairs of transactions over a fifth threshold number of pairs.

11. The method of claim 1, further comprising converting the terminal text of each non-subject POS terminal into multiple terminal text tokens.

12. The method of claim 11, further comprising matching the multiple terminal text tokens to predefined location tokens to identify one or more matching location tokens for each terminal text of the non-subject POS terminals.

13. The method of claim 12, further comprising associating each of the one or more matching location tokens with a geographical location.

14. The method of claim 13, further comprising calculating a plausibility score based on a distance between the geographical location of each of the one or more matching location tokens and a candidate location for the subject POS terminal.

15. The method of claim 14, wherein the plausibility score is based on the time difference and distance or travel speed or both, and indicates whether a trip between locations within the time difference is plausible.

16. (canceled)

17. The method of claim 14, further comprising determining a plausibility weight by combining the plausibility scores of multiple transactions of non-subject terminals for one candidate location of the subject terminal.

18. The method of claim 17, wherein combining the plausibility score comprises calculating a weighted average that is weighted by a weight value for each transaction.

19. The method of claim 17, further comprising calculating an average plausible time difference based on the plausibility weight for each of multiple candidate locations, and
determining the location of the subject POS terminal comprises selecting the candidate location with the highest plausibility weight and/or lowest average plausible time difference.

20. (canceled)

21. A non-transitory computer readable medium that stores computer instructions that, when executed by a computer, cause the computer to perform the method of claim 1.

22. A computer system for determining a location of a subject point-of-sale (POS) terminal, the computer system comprising:
in input port to receive
transaction data from the subject POS terminal including an indication of a transaction time and a payment object used for each of at least one transaction on the subject POS terminal, and
transaction data from at least one non-subject POS terminal for at least one transaction with the payment object, the transaction data including an indication of a transaction time, terminal text and payment object used for each of at least one transaction on the non-subject POS terminal; and
a processor to determine the location of the subject POS terminal by extracting location information from the terminal texts from the at least one non-subject POS terminal based on a difference in the transaction time between the at least one transaction of the subject POS terminal and the at least one transaction of the non-subject POS terminal.
